(19) United States
(12) Patent Application Publication
(10) Pub. No.: US 2026/0370632 A1
(43) Pub. Date: Nov. 19, 2026

(54) DATA ENCRYPTION AND DECRYPTION PROCESSING METHOD AND APPARATUS, ELECTRONIC DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Ruichun FAN, Suzhou, Jiangsu (CN); Junhao WEN, Suzhou, Jiangsu (CN); Ji ZHONG, Suzhou, Jiangsu (CN)

(21) Appl. No.: 19/142,847

(22) PCT Filed: Oct. 24, 2023
(86) PCT No.: PCT/CN2023/126275

§ 371 Date: Jun. 24, 2025

(30) Foreign Application Priority Data
Jan. 18, 2023 (CN) 202310067239.X

(51) Int. Cl. H04L 9/40

(52) U.S. Cl. CPC H04L 63/0428

(57) ABSTRACT

Embodiments of the present application relate to the technical field of data encryption and decryption, and provide a data encryption and decryption processing method and apparatus, an electronic device, and a storage medium. When a write instruction for target data is acquired, the target data is written into a first cache area by means of a data management module, and the target data in the first cache area is encrypted; the encrypted target data in the first cache area is written into a non-volatile storage medium by means of a data write processing module; when a read instruction for the target data is acquired, the encrypted target data in the non-volatile storage medium is read into a second cache area by means of the data write processing module; and the encrypted target data is decrypted by means of the data management module. In the embodiments of the present application, data processing flows are distributed to hardware computing devices where the data management module and the data write processing module are located, so that each hardware computing device has a clear division of labor; the computing power of each hardware computing device is reasonably utilized, so that the data processing efficiency of a solid-state drive is improved.

### CROSS-REFERENCE TO RELATED APPLICATION

The present application claims priority to Chinese patent application No. 202310067239.X. entitled “DATA ENCRYPTION AND DECRYPTION PROCESSING METHOD AND APPARATUS, ELECTRONIC DEVICE, AND STORAGE MEDIUM”, filed on Jan. 18, 2023 before the China National Intellectual Property Administration, which is incorporated herein in its entirety by reference.

### TECHNICAL FIELD

The present application relates to data encryption and decryption technologies, and more particularly to a data encryption and decryption processing method and apparatus, an electronic device, and a non-transient computer readable storage medium.

### BACKGROUND

With the development of society, data security has become increasingly important. Major SSD (Solid State Disk or Solid State Drive) manufacturers also place great emphasis on data security and have adopted various data encryption and decryption technologies to ensure data security. The SM4 algorithm (SMS4 Encryption Algorithm, which is a symmetric encryption algorithm) is a block cipher algorithm in commercial cryptographic algorithms released in China. The SM4 algorithm has become an ISO/IEC (International Organization for Standardization/International Electrotechnical Commission, an international standards organization responsible for formulating and releasing various international standards) international standard, effectively promoting the improvement of the ISO/IEC in symmetric cryptographic algorithm system. This proves the continuous improvement of China's commercial cryptographic technology level and international standardization capabilities, and further enhances the international competitiveness of China's commercial cryptographic industry.

### SUMMARY

Embodiments of the present application provide a method and apparatus for data encryption and decryption processing, an electronic device, and a storage medium.

Embodiments of the present application disclose a data encryption and decryption processing method, applied to a host end that communicates with both a data management module and a data write processing module, the data management module and the data write processing module being located in different hardware computing devices, the method including:
in response to receiving a write instruction for target data, writing, by the data management module, the target data into a first buffer, and encrypting the target data in the first buffer; writing, by the data write processing module, the target data that has been encrypted in the first buffer into a non-transient storage medium;
in response to receiving a read instruction for the target data, reading, by the data write processing module, the encrypted target data in the non-transient storage medium into a second buffer; decrypting, by the data management module, the encrypted target data, and returning the target data that has been decrypted in the second buffer to the host end.

In some embodiments, before writing, by the data management module, the target data into a first buffer, the method further includes:
determining whether the target data needs to be encrypted by analyzing the write instruction via the data management module;
in response to determining that the target data needs to be encrypted, performing the writing, by the data management module, the target data into a first buffer, and encrypting the target data in the first buffer.

In some embodiments, after determining whether the target data needs to be encrypted, the method further includes:
in response to determining that the target data does not need to be encrypted, writing, by the data management module, the target data into the first buffer;
writing, by the data write processing module, the target data in the first buffer into the non-transient storage medium.

In some embodiments, the determining whether the target data needs to be encrypted by analyzing the write instruction via the data management module includes:
parsing, by the data management module, slba field and nlb field from the write instruction, and determining whether the target data corresponding to the slba field and the nlb field needs to be encrypted by looking up a table.

In some embodiments, after determining whether the target data needs to be encrypted, the method further includes:
establishing a flag bit in context of the write instruction by the data management module;
in response to determining that the target data needs to be encrypted, setting the flag bit to 1;
in response to determining that the target data does not need to be encrypted, setting the flag bit to 0.

In some embodiments, the writing, by the data management module, the target data into the first buffer includes:
applying, by the data management module, for the first buffer, and writing the target data into the first buffer.

In some embodiments, after writing, by the data management module, the target data into the first buffer, the method further includes:
transmitting, by the data management module, a preliminary data write completion instruction to the host end, the preliminary data write completion instruction being used for releasing the host end.

In some embodiments, the encrypting the target data in the first buffer includes:
encrypting the target data of a LBA granularity in the first buffer.

In some embodiments, the encrypting the target data of the LBA granularity in the first buffer includes:
traversing the first buffer, and extracting the target data of the LBA granularity from the first buffer;
transmitting the target data of the LBA granularity to an encryption/decryption module for encryption.

In some embodiments, the transmitting the target data of the LBA granularity to the encryption/decryption module for encryption further includes:
in response to failing in transmitting the target data of the LBA granularity to the encryption/decryption module, recording a position of the target data of the LBA granularity that has been encrypted;
in response to determining that a transmission link between the first buffer and the encryption/decryption module is restored, transmitting the target data of the LBA granularity located next to the position to the encryption/decryption module for encryption.

In some embodiments, a source address of the target data of the LBA granularity before encryption and a destination address of the target data of the LBA granularity after encryption are the same.

In some embodiments, before the reading, by the data write processing module, the encrypted target data in the non-transient storage medium into the second buffer, the method further includes:
determining whether the target data needs to be decrypted by analyzing the write instruction via the data management module;
in response to determining that the target data needs to be decrypted, performing the reading, by the data write processing module, the encrypted target data in the non-transient storage medium into the second buffer; and decrypting, by the data management module, the encrypted target data.

In some embodiments, after determining whether the target data needs to be decrypted, the method further includes:
in response to determining that the target data does not need to be decrypted, reading, by the data write processing module, the target data in the non-transient storage medium into the second buffer;
returning, by the data management module, the target data in the second buffer to the host end.

In some embodiments, the determining whether the target data needs to be decrypted by analyzing the write instruction via the data management module includes:
parsing, by the data management module, slba field and nlb field from the write instruction, and determining whether the target data corresponding to the slba field and the nlb field needs to be decrypted by looking up a table.

In some embodiments, after determining whether the target data needs to be decrypted, the method further includes:
establishing a flag bit in context of the read instruction by the data management module;
in response to determining that the target data needs to be decrypted, setting the flag bit to 1;
in response to determining that the target data does not need to be decrypted, setting the flag bit to 0.

In some embodiments, the reading, by the data write processing module, the encrypted target data in the non-transient storage medium into the second buffer includes:
applying, by the data write processing module, for the second buffer, and writing the encrypted target data in the non-transient storage medium into the second buffer.

In some embodiments, the decrypting the encrypted target data includes:
decrypting the target data of the LBA granularity in the second buffer.

In some embodiments, the decrypting the target data of the LBA granularity in the second buffer includes:
traversing the second buffer, and determining the target data of the LBA granularity in the second buffer; and
decrypting the target data of the LBA granularity.

In some embodiments, a source address of the target data of the LBA granularity before decryption and a destination address of the target data of the LBA granularity after decryption are the same.

In some embodiments, after returning the decrypted target data in the second buffer to the host end, the method further includes:
in response to receiving a rewrite instruction for the decrypted target data, encrypting, by the data management module, the decrypted target data in the second buffer;
writing, by the data write processing module, the target data that has been encrypted in the second buffer into the non-transient storage medium.

An embodiment of the present application further provides a data encryption and decryption processing apparatus, applied to a host end that communicates with both a data management module and a data write processing module, the data management module and the data write processing module being located in different hardware computing devices;
in response to receiving a write instruction for target data, the data management module is configured to write the target data into a first buffer and encrypt the target data in the first buffer; the data write processing module is configured to write the target data that has been encrypted in the first buffer into a non-transient storage medium;
in response to receiving a read instruction for the target data, the data write processing module is configured to read the encrypted target data in the non-transient storage medium into a second buffer; the data management module is configured to decrypt the encrypted target data and return the decrypted target data in the second buffer to the host end.

In some embodiments, the data management module is configured to analyze the write instruction to determine whether the target data needs to be encrypted.

When it is determined that the target data needs to be encrypted, the data management module is configured to write the target data into the first buffer and encrypt the target data in the first buffer.

In some embodiments, when it is determined that the target data does not need to be encrypted, the data management module is configured to write the target data into the first buffer.

The data write processing module is used to write the target data in the first buffer into the non-transient storage medium.

In some embodiments, the data management module is configured to parse the slba field and the nlb field from the write instruction and determine whether the target data corresponding to the slba field and the nlb field needs to be encrypted by looking up a table.

In some embodiments, the data management module is configured to establish a flag bit in the context of the write instruction. When it is determined that the target data needs to be encrypted, the flag bit is set to 1. When it is determined that the target data does not need to be encrypted, the flag bit is set to 0.

In some embodiments, the data management module is configured to apply for the first buffer and write the target data into the first buffer.

In some embodiments, the data management module is configured to transmit a preliminary data write completion instruction to the host end. The preliminary data write completion instruction is used to release the host end.

In some embodiments, the data management module is configured to encrypt the target data of the LBA granularity in the first buffer.

In some embodiments, the data management module is configured to traverse the first buffer, extract the target data of the LBA granularity in the first buffer, and transmit the target data of the LBA granularity to the encryption/decryption module.

The encryption/decryption module is configured to encrypt the target data of the LBA granularity.

In some embodiments, when the transmission of the target data of the LBA granularity to the encryption/decryption module fails, the data management module is configured to record the position of the target data of the LBA granularity that has been encrypted. When it is determined that the transmission link between the first buffer and the encryption/decryption module is restored, the target data of the LBA granularity located next to the position is sent to the encryption/decryption module.

In some embodiments, the source address of the target data of the LBA granularity before encryption and destination address of the target data of the LBA granularity after encryption are the same.

In some embodiments, the data management module is configured to analyze the write instruction to determine whether the target data needs to be decrypted.

When it is determined that the target data needs to be decrypted, the data write processing module is configured to read the encrypted target data in the non-transient storage medium into the second buffer, and the data management module is configured to decrypt the encrypted target data.

In some embodiments, when it is determined that the target data does not need to be decrypted, the data write processing module is configured to read the target data in the non-transient storage medium into the second buffer.

The data management module is configured to return the target data in the second buffer to the host end.

In some embodiments, the data management module is configured to parse the slba (Starting Logical Block Address) field and the nlb (Number of Logical Blocks) field from the write instruction, and determine whether the target data corresponding to the slba field and the nlb field needs to be decrypted by looking up a table.

In some embodiments, the data management module is configured to establish a flag bit in the context of the read instruction. When it is determined that the target data needs to be decrypted, the flag bit is set to 1. When it is determined that the target data does not need to be decrypted, the flag bit is set to 0.

In some embodiments, the data write processing module is configured to apply for the second buffer, and write the encrypted target data in the non-transient storage medium into the second buffer.

In some embodiments, the data management module is configured to decrypt the target data in the second buffer of the LBA granularity.

In some embodiments, the data management module is configured to traverse the second buffer, determine the target data of the LBA granularity in the second buffer, and decrypt the target data of the LBA granularity.

In some embodiments, the source address of the LBA granularity before decryption and the destination address of the target data of the LBA granularity after decryption are the same.

In some embodiments, when a rewrite instruction for the decrypted target data is received, the data management module is configured to encrypt the decrypted target data in the second buffer.

The data write processing module is configured to write the encrypted target data in the second buffer into the non-transient storage medium.

An embodiment of the present application also provides an electronic device, including a processor, a communication interface, a memory, and a communication bus, wherein the processor, the communication interface, and the memory communicate with each other via the communication bus; the memory is stored with a computer program; the processor is configured to execute the computer program stored in the memory to implement the method of the present application.

An embodiment of the present application also provides a non-transient computer readable storage medium storing instructions that, when executed by one or more processors, cause the processor to perform the method of the present application.
non-transient

### BRIEF DESCRIPTION OF THE DRAWINGS

FIG. 1 is a flowchart illustrating steps of a data encryption and decryption processing method provided by an embodiment of the present application;

FIG. 2 is a schematic diagram illustrating data writing steps provided by an embodiment of the present application;

FIG. 3 is a schematic diagram illustrating data reading steps provided by an embodiment of the present application;

FIG. 4 is a structural block diagram of a data encryption and decryption processing apparatus provided by an embodiment of the present application;

FIG. 5 is a block diagram of an electronic device provided in an embodiment of the present application; and

FIG. 6 is a block diagram of a non-transient computer readable storage medium provided by an embodiment of the present application.

### DETAILED DESCRIPTION OF THE EMBODIMENTS

In order to make objectives, features, and advantages of the present application clearer and more understandable, the present application will be introduced below in details in conjunction with the accompanying drawings and specific embodiments.

### Definitions of Abbreviations and Key Terms

SSD: Solid State Disk or Solid State Drive;
BP LIST: Buffer Pool List;
HOST: Host end;
NAND: NAND flash memory, a type of non-transient storage medium;
Buffer: Buffer area (buffer register);
DMA: Direct Memory Access;
L2P: Logical-to-Physical Address Translation;
DM: Data Management Module;
WM: Data Write Processing Module;
SRAM: Static Random Access Memory;
FLAG: Flag bit;
REWRITE: Rewriting;
CCB: Cache Control Block;
CPU: Central Processing Unit;
LBA: Linear Block Addressing;
AES: Advanced Encryption Standard, a symmetric encryption algorithm;
RSA: Rivest-Shamir-Adleman, a public-key cryptosystem;
GPU: Graphics Processing Unit;
NPU: Neural Processing Unit;
FPGA: Field-Programmable Gate Array;
BS Particle Size: an indicator used to describe the dispersion degree of a substance.

In the current process of encrypting and decrypting data stored in SSDs using the SM4 algorithm, various complex processes (such as data encryption and decryption processes, data transmission processes) are all processed by the same hardware computing device (such as a central processing unit, CPU). This leads to a relatively low data processing efficiency of SSDs and affects the overall performance.

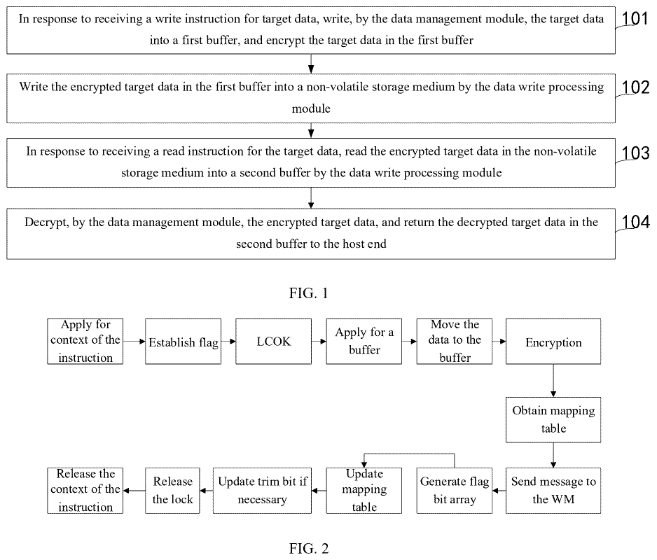

FIG. 1 is a flowchart illustrating steps of a data encryption and decryption processing method provided by an embodiment of the present application. The data encryption and decryption processing method is applied to a host end that communicates with both a data management module and a data write processing module. The steps include steps 101 to 104.
At step 101, when a write instruction for target data is received, the data management module writes the target data into a first buffer, and encrypts the target data in the first buffer.

In this embodiment, the method is illustrated using the SM4 encryption and decryption algorithm, but it is not limited to this. For example, other encryption and decryption algorithms such as AES, RSA can also be adopted.

The data management module and the data write processing module are located in different hardware computing devices, which can be CPUs. However, depending on actual needs, the hardware computing devices can also be GPUs, NPUs, FPGAs, etc. The buffer is an SRAM (Static Random Access Memory) buffer.

Specifically, when receiving a write instruction for the target data, the host end calls the data management module to write the target data from the host end into the first buffer. Then, the data management module encrypts the target data in the first buffer. For example, unex DMA can be used to move the data to the SRAM buffer, and then an encryption process can be initiated to encrypt the target data in the SRAM buffer.
At step 102, the encrypted target data in the first buffer is written into a non-transient storage medium by the data write processing module.

Specifically, after the target data in the first buffer is encrypted, the host end calls the data write processing module to write the encrypted target data into the non-transient storage medium.
At step 103, when a read instruction for the target data is received, the encrypted target data in the non-transient storage medium is read into a second buffer by the data write processing module.

Specifically, when receiving a read instruction for the target data, the host end calls the data write processing module to read the encrypted target data from the non-transient storage medium into the second buffer to facilitate the reading of the target data.
At step 104, the data management module decrypts the encrypted target data, and returns the decrypted target data in the second buffer to the host end.

Specifically, after the data write processing module reads the encrypted target data in the non-transient storage medium into the second buffer, the data management module is needed for decrypting the encrypted target data to obtain the decrypted target data and returning the decrypted target data in the second buffer to the host end.

In this embodiment, by allocating data interaction processes between the host end and the buffer area as well as encryption/decryption procedures to the data management module for processing, while assigning the data interaction processes between the buffer area and the non-transient storage medium to the data write processing module for processing, with these two modules residing on different hardware computing devices, a clear division of labor among the hard computing devices is achieved. This method can not only optimally utilize the computing powers of various hardware computing devices, but also enhance the data processing efficiency of the SSD while maintaining the overall performance thereof.

Based on the above embodiment, a variant embodiment thereof is proposed. It should be noted that, in order to keep the description concise, only the differences from the above embodiment are described in the variant embodiment.

In some embodiments, before the data management module writes the target data into the first buffer, the method further includes: determining whether the target data needs to be encrypted by analyzing the write instruction via the data management module; and in response to determining that the target data needs to be encrypted, performing the step in which the data management module whites the target data into the first buffer and encrypts the target data in the first buffer.

Specifically, when the host end receives a write instruction for the target data, it is necessary to first determine whether the target data needs to be encrypted. If the target data does not need to be encrypted, it can be directly written into the non-transient storage medium. Specifically, for analyzing the write instruction through the data management module, the write instruction typically carries information indicating whether encryption is required. Based on this information, it can determine whether the target data needs to be encrypted.

When it is determined that the target data needs to be encrypted, the step, in which the data management module writes the target data into the first buffer and encrypts the target data in the first buffer, is performed to encrypt the target data and store it in the non-transient storage medium.

In some embodiments, after determining whether the target data needs to be encrypted, the method further includes: when it is determined that the target data does not need to be encrypted, writing the target data into the first buffer by the data management module; and writing the target data from the first buffer into the non-transient storage medium by the data write processing module.

Specifically, when it is determined that the target data does not need to be encrypted, after the target data is written into the first buffer by the data management module, there is no need to encrypt the target data in the first buffer by the data management module. Instead, the data write processing module is directly called to write the target data from the first buffer into the non-transient storage medium.

In some embodiments, determining whether the target data needs to be encrypted by analyzing the write instruction via the data management module includes: parsing the slba (starting logical block address) field and the nlb (number of logical blocks) field from the write instruction by the data management module, and determining whether the target data corresponding to the slba field and the nlb field needs to be encrypted by looking up a table.

Specifically, after receiving the write instruction, the data management module can parse the write instruction to obtain the slba field and the nlb field. Subsequently, by invoking an interface provided by the frontend for table lookup, it can be determined whether the target data corresponding to the slba and nlb fields needs to be encrypted. This facilitates the subsequent processing of the target data.

In some embodiments, after determining whether the target data needs to be encrypted, the method further includes: establishing a flag bit in the context of the write instruction by the data management module; setting the flag bit to 1 when it is determined that the target data needs to be encrypted; and setting the flag bit to 0 when it is determined that the target data does not need to be encrypted.

Specifically, after receiving a write instruction for the target data, the host end can call the data management module to establish a flag bit in the context of the write instruction to indicate whether the IO instruction carried by the instruction needs to be encrypted. The default setting is 0, indicating no encryption is needed. If the flag is set to 1, it indicates that encryption is needed.

In some embodiments, the target data is written into the first buffer through the data management module by: applying, by the data management module, for the first buffer and writing the target data into the first buffer.

Specifically, after receiving a write instruction for the target data, the host end calls the data management module to apply for the first buffer, configure the bp list (buffer pool list), and move the target data to the first buffer through unex DMA.

In some embodiments, after the target data is written into the first buffer by the data management module, the method further includes transmitting a preliminary data write completion instruction from the data management module to the host end. The preliminary data write completion instruction is used for releasing the host end.

In the existing process of writing data into the non-transient storage medium, the host end is continuously occupied until the data is written into the non-transient storage medium. That is, only when the data is written into the non-transient storage medium, the host end is released to handle other tasks.

In the present application, after the target data is written from the host end into the first buffer, subsequent operations do not need to be processed by the host end. At this time, the data management module sends a preliminary data write completion instruction to the host end to release the host end in advance, avoiding continuous occupation of the host end. This allows the host end to handle other tasks without affecting the latency of processing other tasks.

In some embodiments, the target data in the first buffer is encrypted by encrypting the target data in the first buffer at the LBA (Logical Block Address) granularity.

Since LBA is the minimum data processing unit of the host end, data may be written in a large BS (Block Size) granularity but read in a small BS granularity, encryption can only be performed at the LBA granularity.

Specifically, after the DMA (Direct Memory Access) is completed and the target data has been moved to the first buffer configured by the BP LIST, the target data of the LBA granularity size in the first buffer can be encrypted.

In the above embodiments, encryption is performed at the minimum granularity to ensure the flexibility and performance of the read process are not affected. When encrypting at the minimum data granularity, it can proceed to the next encryption process as soon as a message is successfully sent, without waiting for the previous encryption to complete. The encryption process continues until a message transmitting failure occurs. Only the completion of the last encryption needs to be checked.

In some embodiments, encrypting the target data of the LBA granularity in the first buffer includes: traversing the first buffer to extract the target data of the LBA granularity in the first buffer; and transmitting the target data of the LBA granularity to the encryption/decryption module for encryption.

Specifically, the first buffer in the buffer pool list is traversed sequentially to extract each target data of the LBA granularity and send it to the encryption/decryption module for encryption. During the data extraction process, it is necessary to distinguish between 4 k formatted disks and 512 formatted disks. If it is a 4 k formatted disk, only data of 4096 bytes can be extracted for encryption each time. If it is a 512 formatted disk, only data of 512 bytes can be extracted for encryption each time. Moreover, only user data should be encrypted, and the controller's internal metadata should not be encrypted.

In some embodiments, transmitting the target data of the LBA granularity to the encryption/decryption module for encryption further includes: when the transmission of the target data of the LBA granularity to the encryption/decryption module fails, recording a position of the target data of the LBA granularity that has been encrypted; and when it is determined that the transmission link between the first buffer and the encryption/decryption module is restored, transmitting the target data of the LBA granularity at located next to the recorded position to the encryption/decryption module for encryption.

The source address of the target data of the LBA granularity before the encryption and the destination address of the target data of the LBA granularity after the encryption are the same. Therefore, the target data occupies the same location in the first buffer before and after encryption, which not only saves buffer space in the first buffer, but also facilitates the subsequent movement of the encrypted target data to the non-transient storage medium.

Specifically, to minimize the impact of encryption on performance, messages are continuously transmitted to the encryption/decryption module for encryption until a transmission failure occurs. That is, if a piece of target data (of one LBA granularity) is transmitted successfully, the next piece of target data is immediately transmitted for encryption processing without waiting for the result from the encryption/decryption module. If the transmission keeps succeed continuously, the subsequent steps can be performed immediately after the last piece of target data is transmitted successfully.

After the transmission fails, the position of the target data that has been processed is recorded, and the context carrying this piece of data is placed in the pending list. When it is possible to continue transmitting messages, the encryption of the target data of the LBA granularity is resumed, starting from a position next to that recorded when the transmission fails.

After all the data has been encrypted, a L2P (Logical-to-Physical Address Translation) table is obtained, an obsolete flag bit array is generated, information about the CCB (Cache Control Block) is updated, and a message is sent to the WM (Data Write Processing Module). The WM writes the encrypted target data into the NAND (non-transient storage medium). The generated obsolete flag bit array is then processed by vdfb and vdfc, and the L2P table is updated.

In some embodiments, before the encrypted target data in the non-transient storage medium is read to the second buffer by the data write processing module, the method further includes: determining whether the target data needs to be decrypted by analyzing the write instruction via the data management module; and when it is determined that the target data needs to be decrypted, performing the step in which the encrypted target data in the non-transient storage medium is read to the second buffer by the data write processing module and the encrypted target data is decrypted by the data management module.

Specifically, when the host end receives a read instruction for the target data, it is necessary to first determine whether the target data needs to be decrypted. If the target data does not need to be decrypted, the target data can be directly extracted from the non-transient storage medium. Specifically, the data management module analyzes the write instruction. Generally, the write instruction carries indication information on whether encryption is required, and based on this information, it can be determined whether the target data needs to be decrypted.

When it is determined that the target data needs to be decrypted, the step, in which the encrypted target data in the non-transient storage medium is read to the second buffer by the data write processing module and the encrypted target data is decrypted by the data management module, is performed to return the decrypted target data to the host end.

In some embodiments, after determining whether the target data needs to be decrypted, the method further includes: when it is determined that the target data does not need to be decrypted, reading the target data in the non-transient storage medium to the second buffer by the data write processing module; and returning the target data in the second buffer to the host end by the data management module.

Specifically, if it is determined that the target data does not need to be decrypted, after the target data in the non-transient storage medium is read to the second buffer by the data write processing module, the target data in the second buffer is returned to the host end by the data management module, without decrypting the target data in the second buffer by the data management module.

In some embodiments, determining whether the target data needs to be decrypted by analyzing the write instruction through the data management module includes: parsing the slba field and the nlb field from the write instruction by the data management module, and determining whether the target data corresponding to the slba field and the nlb field needs to be decrypted by looking up a table.

Specifically, after receiving a read instruction, the host end can obtain the slba field and the nlb field by parsing the write instruction through the data management module. By calling the interface provided by the front end to look up the table, it can be determined whether the target data corresponding to the slba field and the nlb field needs to be decrypted, so that the target data can be processed accordingly.

In some embodiments, after determining whether the target data needs to be decrypted, the method further includes: establishing a flag bit in the context of the read instruction by the data management module; setting the flag bit to 1 when it is determined that the target data needs to be decrypted; and setting the flag bit to 0 when it is determined that the target data does not need to be decrypted.

Specifically, after receiving a write instruction for the target data, the host end can call the data management module to establish a flag bit in the context of the write instruction to indicate whether the IO instruction carried by the instruction needs to be encrypted. The default setting is 0, indicating no encryption is needed. If the flag is set to 1, it indicates that encryption is required.

In some embodiments, the encrypted target data in the non-transient storage medium is read to the second buffer through the data write processing module by: applying, by the data write processing module, for the second buffer and writing the encrypted target data in the non-transient storage medium into the second buffer.

Specifically, after receiving a read instruction for the target data, the host end calls the data write processing module to apply for the second buffer, configure the buffer pool list (bp list), and use unex dma to move the target data from the non-transient storage medium to the second buffer.

In some embodiments, the encrypted target data is decrypted by: decrypting the target data of the LBA granularity in the second buffer.

The source address and destination address of the target data of the LBA granularity before and after decryption are the same.

Specifically, after receiving the data from the data write processing module, the data management module decrypts the target data of the LBA granularity. Since the decryption interface supports that the data has the the source address and the destination address, the decrypted data is still stored in the second buffer.

In some embodiments, decrypting the target data of the LBA granularity in the second buffer includes: traversing the second buffer to determine the target data of the LBA granularity in the second buffer; and decrypting the target data of the LBA granularity.

Specifically, the data management module traverses the read buffer (second buffer) configured in the bp list at the LBA granularity, extracts the encrypted target data from the second buffer at the LBA granularity, and transmits the extracted data of the LBA granularity to the encryption/decryption module to decrypt each data of the LBA granularity.

In some embodiments, after returning the decrypted target data in the second buffer to the host end, the method further includes: when a rewrite instruction for the decrypted target data is received, encrypting the decrypted target data in the second buffer by the data management module; and writing the encrypted target data in the second buffer into the non-transient storage medium by the data write processing module.

Specifically, after the decrypted target data in the second buffer is returned to the host end, the second buffer still caches the decrypted target data. If the data management module receives a rewrite instruction for the target data at this time, there is no need to write the target data from the host end into the buffer area. Instead, the data management module directly encrypts the decrypted target data in the second buffer. After the target data is encrypted, the data write processing module writes the encrypted target data in the second buffer into the non-transient storage medium.

In the above embodiments, when the data management module receives a rewrite instruction for the target data, the data management module directly encrypts the decrypted target data in the second buffer without the need to write the target data from the host end into the buffer area. This improves the efficiency of the operation and does not affect the host end's ability to read the target data.

To better understand the embodiments of the present application, the following illustrative explanations are provided with reference to FIG. 2 and FIG. 3.

FIG. 2 is a schematic diagram illustrating data writing steps provided in the embodiments of the present application.
(1) In the context of the instruction (write instruction/cmd) used in the write process, a flag (flag bit) is established to indicate whether the IO instruction carried by this instruction needs to be encrypted. The default setting of the flag bit is 0, indicating no encryption is required.
(2) For each write IO instruction received, the slba and nlb fields are parsed from the instruction. The interface provided by the front end is called to look up the table to determine whether this IO instruction needs to be encrypted. If encryption is required, the flag established in step (1) is set to 1 for later use.
(3) After applying for an sram buffer (first buffer), configuring the bp list, and moving the data to the sram buffer through unex DMA, the flag bit set in step (1) is checked.

\textcircled{1} If the flag bit is 0, it indicates that no encryption is required, and the process proceeds directly to step (4); otherwise, encryption is required, and step \textcircled{2} is executed.
\textcircled{2} Start the encryption process: Since the minimum data processing unit of the host is LBA, it is possible to write at a large BS granularity but read at a small BS granularity. Therefore, encryption can only be performed at the LBA granularity. After DMA (Direct Memory Access) is completed, all data carried by this instruction has been moved to the sram buffer configured by the bp list (buffer pool list).
\textcircled{3} Traverse the sram buffer in the bp list sequentially. Each data of the LBA granularity is extracted from the buffer and sent to the encryption/decryption module for encryption. During the data extraction process, it is necessary to distinguish between 4 k formatted disks and 512 formatted disks. If it is a 4 k formatted disk, only data of 4096 bytes can be extracted for encryption each time. If it is a 512 formatted disk, only data of 512 bytes can be extracted for encryption each time. Note that only user data should be encrypted, and the controller's internal meta data should not be encrypted. The source and destination addresses in the encryption interface can be the same, which does not significantly impact performance. Therefore, when encrypting each segment of data, the source and destination addresses can be set to the same address, eliminating the need for additional buffer space.
\textcircled{4} To minimize the impact of encryption on performance, messages are continuously transmitted to the encryption/decryption module for encryption until a transmission failure occurs. That is, if a piece of target data in step \textcircled{3} is transmitted successfully, the next piece of target data is immediately transmitted for encryption processing without waiting for the result from the encryption/decryption module. If the transmission keeps succeed continuously, the step (4) can be performed immediately after the last piece of target data is transmitted successfully. Otherwise, the process proceeds to step \textcircled{5}.
\textcircled{5} After the transmission fails, the position of the data that has been processed is recorded and the context carrying this piece of data is placed into the pending list. When it is possible to continue transmitting messages, the process returns to step 3 to resume processing from a position next to that recorded when the transmission fails.
(4) After all the data has been encrypted, the L2P table (mapping table) is obtained and an obsolete flag bit array is generated.
(5) The CCB (Cache Control Block) information is updated, and a message is sent to the WM (data write processing module). The WM writes to the NAND (non-transient storage medium).
(6) vdfb and vdfc processing is performed based on the obsolete flag bit array generated in step (4).
(7) The L2P table is updated, the lock is released, and the context of the instruction is released.

FIG. 3 is a schematic diagram illustrating data reading steps provided in the embodiments of the present application.
(8) When the host reads data, the DM (Data Management module) first applies for context of a read instruction, and adds a flag in this instruction to indicate whether this instruction needs decryption. The default setting of the flag is 0, indicating no decryption is required.
(9) The DM uses the slba and nlb fields to call the interface provided by the front end to look up the table to determine whether this IO instruction needs decryption. If decryption is required, the flag added in step (8) is set to 1 for later use.
(10) The DM transmits a read request to the WM (data write processing module).
(11) The WM applies for a read buffer (second buffer), sends a message to the backend to read the data into the buffer, configures the bp list, and then sends a read completion message to the DM.
(12) After receiving the read completion message from the WM, the DM traverses the read buffer configured in the bp list at the LBA granularity, and decrypts each piece of data the LBA granularity. Since the decryption interface supports that the data has the same source address and destination address, the data is decrypted directly into the read buffer.
(13) After all the data has been decrypted, the data is returned to the host via DMA.
(14) It is determined whether a rewrite is needed. If not, a completion message is sent to the WM, so that the WM releases the read buffer. Then, the DM releases the lock and the context of the instruction.
(15) If a rewrite is needed, the DM first releases the lock and then initiates a rewrite process. During the rewrite process, the DM does not need to copy the data from the read buffer to the write buffer. Since the data needs to be re-encrypted, the source address is set to the address of the read buffer, and the destination address is set to the address of the write buffer. In this way, data is copied during the encryption process.
(16) After encryption completes, proceed to step (4) to write the data to the backend.

In the above embodiments, the code architecture has been redesigned. The processes related to data interaction with the HOST, such as DMA and encryption/decryption, are placed on the core where the DM resides. The processes related to data interaction with the NAND, such as applying for the read buffer, generating the bp list, and reading from the NAND, are placed on the core where the WM resides. In this way, the CPUs have a clear division of labor. This not only makes rational use of the computing power of each CPU without affecting the overall performance of the SSD, but also makes the code architecture clearer, simpler, and easier to maintain.

During the encryption process, the HOST is released in advance after the data is written to the read buffer via DMA, without affecting the latency. Encryption is performed at the minimum granularity to ensure the flexibility and performance of the read process are not affected. When encrypting at the minimum data granularity, it can proceed to the next encryption process as soon as a message is successfully sent, without waiting for the previous encryption to complete. The encryption process continues until a message transmitting failure occurs. Only the completion of the last encryption needs to be checked. This effectively reduces the latency of encryption and decryption.

During the rewrite process, the different source and destination addresses are used to simultaneously achieve encryption and data movement.

It should be noted that for the method embodiments, in order to simplify the description, they are all described as a series of actions. However, those skilled in the art should know that the embodiments of the present application are not limited by the described order of actions. According to the embodiments of the present application, some steps can be performed in other orders or simultaneously. Secondly, those skilled in the art should also be aware that the described embodiments in the specification are all preferred embodiments, and the involved actions are not necessarily essential for the embodiments of the present application.

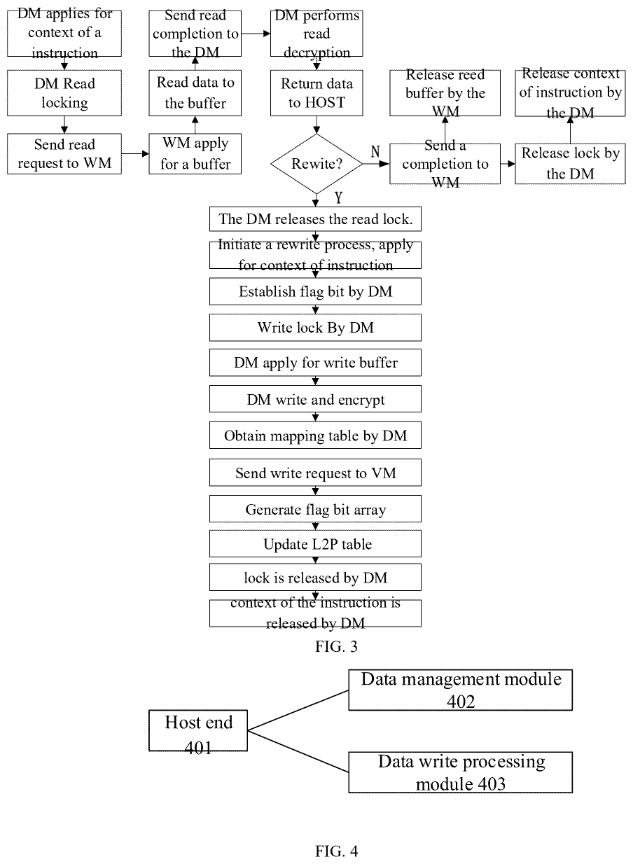

FIG. 4 is a structural block diagram of a data encryption and decryption processing apparatus provided in an embodiment of the present application. The data encryption and decryption processing apparatus is applied to a host end 401 that communicates with both the data management module 402 and the data write processing module 403. The data management module 402 and the data write processing module 403 are located in different hardware computing devices.

When a write instruction for the target data is received, the data management module 402 is used to write the target data into the first buffer and encrypt the target data in the first buffer; the data write processing module 403 is used to write the target data that has been encrypted in the first buffer into a non-transient storage medium.

When a read instruction for the target data is received, the data write processing module 403 is used to read the encrypted target data in the non-transient storage medium into the second buffer; the data management module 402 is used to decrypt the encrypted target data and return the decrypted target data in the second buffer to the host end.

In some embodiments, the data management module is used to analyze the write instruction to determine whether the target data needs to be encrypted.

When it is determined that the target data needs to be encrypted, the data management module is used to write the target data into the first buffer and encrypt the target data in the first buffer.

In some embodiments, when it is determined that the target data does not need to be encrypted, the data management module is used to write the target data into the first buffer.

The data write processing module is used to write the target data in the first buffer into the non-transient storage medium.

In some embodiments, the data management module is used to parse the slba field and the nlb field from the write instruction and determine whether the target data corresponding to the slba field and the nlb field needs to be encrypted by looking up a table.

In some embodiments, the data management module is used to establish a flag bit in the context of the write instruction. When it is determined that the target data needs to be encrypted, the flag bit is set to 1. When it is determined that the target data does not need to be encrypted, the flag bit is set to 0.

In some embodiments, the data management module is used to apply for the first buffer and write the target data into the first buffer.

In some embodiments, the data management module is used to send a preliminary data write completion instruction to the host end. The preliminary data write completion instruction is used to release the host end.

In some embodiments, the data management module is used to encrypt the target data of the LBA granularity in the first buffer.

In some embodiments, the data management module is used to traverse the first buffer, extract the target data of the LBA granularity in the first buffer, and transmit the target data of the LBA granularity to the encryption/decryption module.

The encryption/decryption module is used to encrypt the target data of the LBA granularity.

In some embodiments, when the transmission of the target data of the LBA granularity to the encryption/decryption module fails, the data management module is used to record the position of the target data of the LBA granularity that has been encrypted. When it is determined that the transmission link between the first buffer and the encryption/decryption module is restored, the target data of the LBA granularity located next to the position is sent to the encryption/decryption module.

In some embodiments, the source address of the target data of the LBA granularity before encryption and destination address of the target data of the LBA granularity after encryption are the same.

In some embodiments, the data management module is used to analyze the write instruction to determine whether the target data needs to be decrypted.

When it is determined that the target data needs to be decrypted, the data write processing module is used to read the encrypted target data in the non-transient storage medium into the second buffer, and the data management module is used to decrypt the encrypted target data.

In some embodiments, when it is determined that the target data does not need to be decrypted, the data write processing module is used to read the target data in the non-transient storage medium into the second buffer.

The data management module is used to return the target data in the second buffer to the host end.

In some embodiments, the data management module is used to parse the slba (Starting Logical Block Address) field and the nlb (Number of Logical Blocks) field from the write instruction, and determine whether the target data corresponding to the slba field and the nlb field needs to be decrypted by looking up a table.

In some embodiments, the data management module is used to establish a flag bit in the context of the read instruction. When it is determined that the target data needs to be decrypted, the flag bit is set to 1. When it is determined that the target data does not need to be decrypted, the flag bit is set to 0.

In some embodiments, the data write processing module is used to apply for the second buffer, and write the encrypted target data in the non-transient storage medium into the second buffer.

In some embodiments, the data management module is used to decrypt the target data in the second buffer of the LBA granularity.

In some embodiments, the data management module is used to traverse the second buffer, determine the target data of the LBA granularity in the second buffer, and decrypt the target data of the LBA granularity.

In some embodiments, the source address of the target data of the LBA granularity before decryption and destination address of the target data of the LBA granularity after decryption are the same.

In some embodiments, when a rewrite instruction for the decrypted target data is received, the data management module is used to encrypt the decrypted target data in the second buffer.

The data write processing module is used to write the encrypted target data in the second buffer into the non-transient storage medium.

For the device embodiments, since they are basically similar to the method embodiments, the description is relatively simple. For related details, reference is made to the parts of the method embodiments.

In addition, the embodiments of the present application also provide an electronic device, including: a processor and a memory storing a computer program that when executed by the processor, implements the processes of the above data acquisition method embodiments and achieves the same technical effects. To avoid repetition, it is not described here again.

The embodiments of the present application also provide a non-transient computer readable storage medium. The non-transient computer readable storage medium is stored with a computer program. When the computer program is executed by the processor, it implements the processes of the above data acquisition method embodiments and achieves the same technical effects. To avoid repetition, it is not described here again. The non-transient computer readable storage medium includes, for example, read-only memory (ROM), random access memory (RAM), magnetic disks, or optical discs.

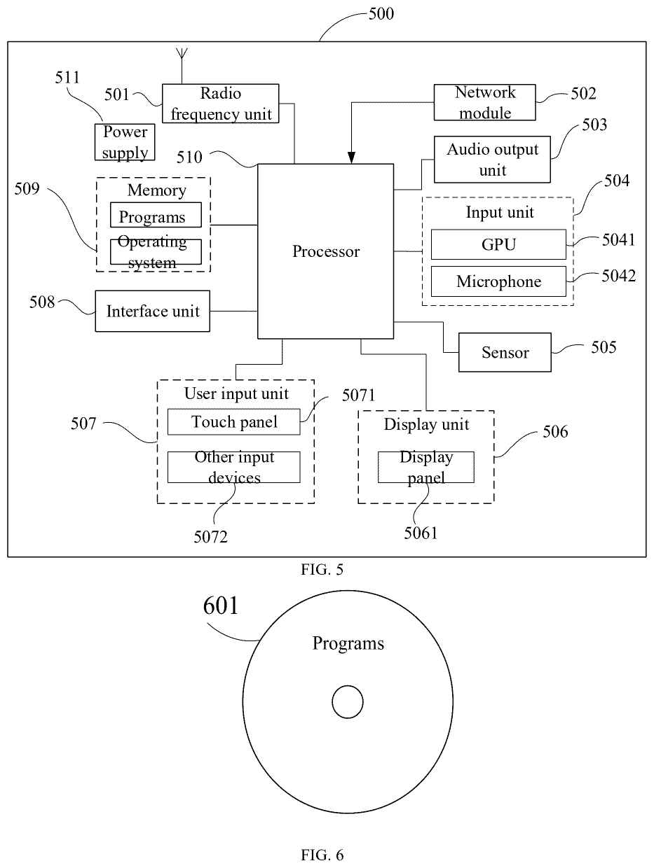

FIG. 5 is a hardware structure diagram of an electronic device for implementing the various embodiments of the present application.

The electronic device 500 includes, but is not limited to: a radio frequency unit 501, a network module 502, an audio output unit 503, an input unit 504, sensors 505, a display unit 506, a user input unit 507, an interface unit 508, a memory 509, a processor 510, and a power supply 511, and the like. Those skilled in the art may understand that the structures of the electronic device shown in FIG. 5 do not constitute a limitation on the electronic device. The electronic device may include more or fewer components than shown in the figure, or combine certain components, or have different component layouts. In the embodiments of the present application, the electronic device includes, but is not limited to, mobile phones, tablet computers, laptops, handheld computers, in-vehicle terminals, wearable devices, and pedometers.

It should be understood that, in the embodiments of the present application, the radio frequency unit 501 can be used for receiving and transmitting information or signals in the process of communication. Specifically, the radio frequency unit 501 can receive downlink data from the base station and pass it to the processor 510 for processing; and transmit uplink data to the base station. Typically, the radio frequency unit 501 includes, but is not limited to, antennas, at least one amplifier, transceivers, couplers, low-noise amplifiers, duplexers, etc. In addition, the radio frequency unit 501 can also communicate with networks and other devices through a wireless communication system.

The electronic device provides wireless broadband Internet access to users through the network module 502, such as helping users send and receive emails, browse web pages, and access streaming media.

The audio output unit 503 can convert audio data received by the radio frequency unit 501 or the network module 502, or stored in the memory 509, into audio signals and output them as sound. Moreover, the audio output unit 503 can also provide audio output related to specific functions performed by the electronic device 500 (for example, call signal reception sound, message reception sound, etc.). The audio output unit 503 includes a speaker, a buzzer, and a receiver, among others.

The input unit 504 is used to receive audio or video signals. The input unit 504 can include a Graphics Processing Unit (GPU) 5041 and a microphone 5042. The GPU 5041 processes image data obtained by an image capture device (such as a camera) in video capture mode or image capture mode. The processed image frames can be displayed on the display unit 506. The processed image frames can be stored in the memory 509 (or other storage media) or sent via the radio frequency unit 501 or the network module 502. The microphone 5042 can receive sound and process it into audio data. The processed audio data can be converted into a format that can be sent to a mobile communication base station via the radio frequency unit 501 in telephone call mode.

The electronic device 500 also includes at least one sensor 505, such as an optical sensor, a motion sensor, and other sensors. Specifically, light sensors include ambient light sensors and proximity sensors. An ambient light sensor can adjust the brightness of the display panel 5061 according to the brightness of the ambient light. A proximity sensor can turn off the display panel 5061 and/or backlight when the electronic device 500 is moved to the ear. As a type of motion sensor, an accelerometer can detect the magnitude of acceleration in various directions (usually three axes). When stationary, it can detect the magnitude and direction of gravity and can be used to identify the orientation of the electronic device (for example, switching between landscape and portrait modes, related games, magnetometer orientation calibration), vibration recognition-related functions (such as pedometer, tapping), etc. The sensor 505 can also include a fingerprint sensor, a pressure sensor, an iris sensor, a molecular sensor, a gyroscope, a barometer, a hygrometer, a thermometer, an infrared sensor, etc., which are not further described here.

The display unit 506 is used to display information input by the user or provided to the user. The display unit 506 can include a display panel 5061, which can be configured in the form of a Liquid Crystal Display (LCD), an Organic Light-Emitting Diode (OLED), or other forms.

The user input unit 507 can be used to receive input of digital or character information and generate key signal inputs related to user settings and functional control of the electronic device. Specifically, the user input unit 507 includes a touch panel 5071 and other input devices 5072. The touch panel 5071, also known as a touchscreen, can collect user touch operations (for example, users using fingers, styluses, or any suitable objects or accessories to operate on or near the touch panel 5071). The touch panel 5071 can include a touch detection device and a touch controller. The touch detection device detects the user's touch position and the signal brought by the touch operation, and transmits the signal to the touch controller. The touch controller receives the touch information from the touch detection device, converts it into touch coordinates, and then sends it to the processor 510, which executes the instructions received from the processor 510. In addition, the touch panel 5071 can be implemented in various types such as resistive, capacitive, infrared, and surface acoustic wave. In addition to the touch panel 5071, the user input unit 507 can also include other input devices 5072. Specifically, other input devices 5072 can include, but are not limited to, physical keyboards, function keys (such as volume control keys, power keys, etc.), trackballs, mice, joysticks, and the like, which are not further described here.

Furthermore, the touch panel 5071 can be overlaid on the display panel 5061. When the touch panel 5071 detects a touch operation on or near it, it sends the information to the processor 510 to determine the type of touch event. Subsequently, the processor 510 provides corresponding visual output on the display panel 5061 based on the type of touch event. Although in FIG. 5, the touch panel 5071 and the display panel 5061 are shown as two separate components to implement the input and output functions of the electronic device, in some embodiments, the touch panel 5071 and the display panel 5061 can be integrated to implement the input and output functions of the electronic device, with no specific limitations here.

The interface unit 508 is an interface for connecting external devices to the electronic device 500. For example, external devices can include wired or wireless headset ports, external power (or battery charger) ports, wired or wireless data ports, storage card ports, ports for connecting devices with identification modules, audio input/output (I/O) ports, video I/O ports, headphone ports, etc. The interface unit 507 can be used to receive input from external devices (such as data information, power, etc.) and transmit the received input to one or more components within the electronic device 500, or it can be used to transmit data between the electronic device 500 and external devices.

The memory 509 can be used to store software programs and various data. The memory 509 mainly includes a program storage area and a data storage area. The program storage area can store operating systems, applications required for various functions (such as audio playback functions, image playback functions, etc.). The data storage area can store data created according to the use of the mobile phone (such as audio data, phone book, etc.). In addition, the memory 509 can include high-speed random access memory and can also include non-transient memory, such as at least one disk storage device, flash memory device, or other volatile solid-state storage devices.

The processor 510 is the control center of the electronic device. It connects various parts of the entire electronic device through various interfaces and lines. By running or executing software programs and/or modules stored in the memory 509 and calling data stored in the memory 509, the processor 510 performs various functions of the electronic device and processes data, thereby monitoring the electronic device as a whole. The processor 510 can include one or more processing units. Preferably, the processor 510 can integrate an application processor and a modem The embodiments of the present application also provide a non-transient computer readable storage medium as shown in FIG. 6. The non-transient computer readable storage medium is stored with a computer program 601. When the computer program 601 is executed by a processor, it implements the processes of the above data acquisition method embodiments and achieves the same technical effects. To avoid repetition, it is not described here again. The non-transient computer readable storage medium includes, for example, Read-Only Memory (ROM), Random Access Memory (RAM), magnetic disks, or optical discs.

It should be noted that, in this article, the terms “include,” “comprise,” or any other variants are intended to cover non-exclusive inclusion. Thus, a process, method, item, or device that includes a series of elements not only includes those elements but also includes other elements not explicitly listed, or elements inherent to such a process, method, item, or device. Unless otherwise specified, an element defined by the phrase “including a . . . ” does not exclude the presence of additional identical elements in the process, method, item, or device that includes the element.

Through the above description of the implementation methods, those skilled in the art can clearly understand that the above implementation methods can be realized by software plus a necessary general hardware platform. Of course, it can also be realized by hardware. However, in many cases, the former is a better implementation method. Based on this understanding, the technical solution of the present application, essentially or the part that makes a contribution to the existing technology, can be embodied in the form of a software product. The computer software product is stored in a storage medium (such as ROM/RAM, magnetic disks, optical discs), including several instructions to make a terminal (which can be a mobile phone, computer, resource server, air conditioner, or network device) execute the methods of various embodiments of the present application.

The above description of the implementation of the present application in combination with the accompanying drawings is only illustrative. However, the present application is not limited to the specific implementation methods described above. The specific implementation methods described above are only illustrative and not restrictive. Under the inspiration of the present application, those skilled in the art can make many forms without departing from the purpose and scope of the present application, all of which are within the scope of protection of the present application.

Those skilled in the art can realize that the units and algorithm steps described in the embodiments disclosed in the present application can be implemented by electronic hardware or a combination of computer software and electronic hardware. Whether these functions are executed in hardware or software depends on the specific application and design constraints of the technical solution. Those skilled in the art can use different methods to implement the described functions for each specific application, but such implementation should not be considered beyond the scope of the present application.

Those skilled in the art can clearly understand that, for the convenience and simplicity of description, the specific working processes of the above-described systems, devices, and units can refer to the corresponding processes in the above method embodiments, and will not be repeated here.

In the embodiments provided by the present application, it should be understood that the disclosed devices and methods can be implemented in other ways. For example, the above-described device embodiments are only illustrative. For example, the division of units is only a logical function division. In actual implementation, there can be other division methods. For example, multiple units or components can be combined or integrated into another system, or some features can be ignored or not executed. Another point is that the coupling or direct coupling or communication connection displayed or discussed can be an indirect coupling or communication connection through some interfaces, devices, or units, and can be in the form of electrical, mechanical, or other forms.

Units described as separate components may or may not be physically separate, and components displayed as units may or may not be physical units. That is, they can be located in one place or distributed across multiple network units. Depending on the actual needs, some or all units can be selected to achieve the purpose of the implementation of this embodiment.

In addition, in the various embodiments of the present application, each functional unit can be integrated into one processing unit, or each unit can exist separately, or two or more units can be integrated into one unit.

If the function is implemented in the form of a software functional unit and sold or used as an independent product, it can be stored in a computer-readable storage medium. Based on this understanding, the technical solution of the present application, essentially or the part that makes a contribution to the existing technology, or a part of the technical solution can be embodied in the form of a software product. The computer software product is stored in a storage medium and includes several instructions to make a computer device (which can be a personal computer, a resource server, or a network device) execute all or part of the steps of the methods of various embodiments of the present application. The storage medium mentioned above includes: USB drives, mobile hard disks, ROM, RAM, magnetic disks, or optical discs, and various other media that can store program code.

The above are only specific implementation methods of the present application, but the scope of protection of the present application is not limited to this. Any changes or substitutions that can be easily conceived by those skilled in the art within the technical scope disclosed by the present application should be covered within the scope of protection of the present application. Therefore, the protection scope of the present application should be subject to the scope of protection of the claims.

1. A data encryption and decryption processing method, applied to a host end that communicates with both a first processor and a second processor, the first processor and the second processor being located in different hardware computing devices, the method comprising:
in response to receiving a write instruction for target data, writing, by the first processor, the target data in the host end into a first buffer, and encrypting the target data in the first buffer; writing, by the second processor, the target data that has been encrypted in the first buffer into a non-transient storage medium;
in response to receiving a read instruction for the target data, reading, by the second processor, the encrypted target data in the non-transient storage medium into a second buffer; decrypting, by the first processor, the encrypted target data, and returning the target data that has been decrypted in the second buffer to the host end.

2. The method according to claim 1, wherein before writing, by the first processor, the target data into a first buffer, the method further comprises:
determining whether the target data needs to be encrypted by analyzing the write instruction via the first processor;
in response to determining that the target data needs to be encrypted, performing the writing, by the first processor, the target data into a first buffer, and encrypting the target data in the first buffer.

3. The method according to claim 2, wherein after determining whether the target data needs to be encrypted, the method further comprises:
in response to determining that the target data does not need to be encrypted, writing, by the first processor, the target data into the first buffer;
writing, by the second processor, the target data in the first buffer into the non-transient storage medium.

4. The method according to claim 2, wherein the determining whether the target data needs to be encrypted by analyzing the write instruction via the first processor comprises:
parsing, by the first processor, slba field and nlb field from the write instruction, and determining whether the target data corresponding to the slba field and the nlb field needs to be encrypted by looking up a table.

5. The method according to claim 2, wherein after determining whether the target data needs to be encrypted, the method further comprises:
establishing a flag bit in context of the write instruction by the first processor;
in response to determining that the target data needs to be encrypted, setting the flag bit to 1;
in response to determining that the target data does not need to be encrypted, setting the flag bit to 0.

6. The method according to claim 1, wherein the writing, by the first processor, the target data into the first buffer comprises:
applying, by the first processor, for the first buffer, and writing the target data into the first buffer.

7. The method according to claim 1, wherein after writing, by the first processor, the target data into the first buffer, the method further comprises:
transmitting, by the first processor, a preliminary data write completion instruction to the host end, the preliminary data write completion instruction being used for releasing the host end.

8. The method according to claim 1, wherein the encrypting the target data in the first buffer comprises:
encrypting the target data of a LBA granularity in the first buffer;
wherein a source address of the target data of the LBA granularity before encryption and a destination address of the target data of the LBA granularity after encryption are the same.

9. The method according to claim 8, wherein the encrypting the target data of the LBA granularity in the first buffer comprises:
traversing the first buffer, and extracting the target data of the LBA granularity from the first buffer;
transmitting the target data of the LBA granularity to third processor for encryption.

10. The method according to claim 9, wherein the transmitting the target data of the LBA granularity to the third processor for encryption further comprises:
in response to failing in transmitting the target data of the LBA granularity to the third processor, recording a position of the target data of the LBA granularity that has been encrypted;
in response to determining that a transmission link between the first buffer and the third processor is restored, transmitting the target data of the LBA granularity located next to the position to the third processor for encryption.

11. (canceled)

12. The method according to claim 1, wherein before the reading, by the second processor, the encrypted target data in the non-transient storage medium into the second buffer, the method further comprises:
determining whether the target data needs to be decrypted by analyzing the write instruction via the first processor;
in response to determining that the target data needs to be decrypted, performing the reading, by the second processor, the encrypted target data in the non-transient storage medium into the second buffer; and decrypting, by the first processor, the encrypted target data.

13. The method according to claim 12, wherein after determining whether the target data needs to be decrypted, the method further comprises:
in response to determining that the target data does not need to be decrypted, reading, by the second processor, the target data in the non-transient storage medium into the second buffer;
returning, by the first processor, the target data in the second buffer to the host end.

14. The method according to claim 13, wherein the determining whether the target data needs to be decrypted by analyzing the write instruction via the first processor comprises:
parsing, by the first processor, slba field and nlb field from the write instruction, and determining whether the target data corresponding to the slba field and the nlb field needs to be decrypted by looking up a table.

15. The method according to claim 14, wherein after determining whether the target data needs to be decrypted, the method further comprises:
establishing a flag bit in context of the read instruction by the first processor;
in response to determining that the target data needs to be decrypted, setting the flag bit to 1;
in response to determining that the target data does not need to be decrypted, setting the flag bit to 0.

16. The method according to claim 1, wherein the reading, by the second processor, the encrypted target data in the non-transient storage medium into the second buffer comprises:
applying, by the second processor, for the second buffer, and writing the encrypted target data in the non-transient storage medium into the second buffer.

17. The method according to claim 1, wherein the decrypting the encrypted target data comprises:
decrypting the target data of the LBA granularity in the second buffer.

18. The method according to claim 17, wherein the decrypting the target data of the LBA granularity in the second buffer comprises:
traversing the second buffer, and determining the target data of the LBA granularity in the second buffer; and
decrypting the target data of the LBA granularity;
wherein a source address of the target data of the LBA granularity before decryption and a destination address of the target data of the LBA granularity after decryption are the same.

19. (canceled)

20. The method according to claim 1, wherein after returning the decrypted target data in the second buffer to the host end, the method further comprises:
in response to receiving a rewrite instruction for the decrypted target data, encrypting, by the first processor, the decrypted target data in the second buffer;
writing, by the second processor, the target data that has been encrypted in the second buffer into the non-transient storage medium.

21. (canceled)

22. An electronic device, comprising a processor, a communication interface, a memory, and a communication bus, wherein the processor, the communication interface, and the memory communicate with each other via the communication bus;
the memory is stored with a computer program;
the processor is configured to execute the computer program stored in the memory to implement the method of claim 1.

23. A non-transient computer readable storage medium storing instructions that, when executed by one or more processors, cause the processor to perform the method of claim 1.
